(19) United States
(12) Patent Application Publication
(10) Pub. No.: US 2024/0301534 A1
(43) Pub. Date: Sep. 12, 2024

(54) METHOD FOR SYNTHESIZING INTERMETALLIC ALLOY NANOPARTICLES

(71) Applicant: City University of Hong Kong, Hong Kong (HK)

(72) Inventors: Hua ZHANG, Hong Kong (HK); Biao HUANG, Hong Kong (HK); Yiyao GE, Hong Kong (HK)

(21) Appl. No.: 18/182,357

(22) Filed: Mar. 12, 2023

(51) Int. Cl. C22C 13/00; C22C 1/047; C22C 5/04; C25B 3/23; C25B 11/046

(52) U.S. Cl. CPC C22C 13/00; C22C 1/047; C22C 5/04; C25B 3/23; C25B 11/046

(57) ABSTRACT

A general and well-controlled method for synthesizing intermetallic nanoparticles is provided. The method comprises: preparing noble-metal nanoparticle seeds; dispersing a metal precursor into the noble-metal nanoparticle seeds to form a first solution; adding the first solution into an organic solvent to form a first mixture; sonicating the first mixture at room temperature; subjecting the first mixture to a heat treatment under N₂ atmosphere to render a second solution; cooling the second solution naturally to room temperature; adding ethanol to the second solution to form a third solution; and collecting the intermetallic nanoparticle from the third solution by centrifugation. The as-synthesized hollow orthorhombic Pd₂Sn alloy nanoparticles can accelerate the cleavage of C—C bond when compared with commercial Pd/C and display superior catalytic performance towards glycerol oxidation reaction and potential for promising applications.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to synthesis of intermetallic nanoparticles. More specifically the present invention relates to controllable synthesis of noble-metal based intermetallic nanoparticles with hollow or solid architectures.

### BACKGROUND OF THE INVENTION

Noble metals have been intensively explored as promising candidates for versatile applications, especially in catalysis, owing to their unique physicochemical properties, while their practical application still suffers from the high cost and scarcity. Therefore, numerous research efforts have been devoted to developing high-performance catalysts with reduced content and increased utilization efficiency of noble metals. Specifically, alloying noble metals with high-abundance non-noble metals has been regarded as an appealing route, which not only reduces the usage of noble metals but also enhances their catalytic performances due to the synergistic effect of different metal atoms. Besides, the construction of hollow architectures in noble metal catalysts offers another promising approach to achieving this goal. Benefiting from the large specific surface area and open architecture, hollow noble metal catalysts could provide more exposed surface sites compared with their solid counterparts, thus enhancing the noble-metal utilization efficiency. To date, preparing noble metal-based alloys with hollow architectures has attracted extensive research attention for achieving high catalytic performance. However, the current studies are mainly limited to hollow noble metal-based alloys with conventional thermodynamically stable crystal phases.

Recently, phase engineering of nanomaterials (PEN) has been proven as a compelling strategy to modulate the intrinsic properties of noble metal-based nanomaterials and boost their catalytic performances by precisely tuning the atomic arrangements, which stimulates the synthesis of noble metal-based alloys with unconventional phases and allows the exploration of their phase-dependent properties and applications. In particular, noble metal-based intermetallic alloys with ordered atomic arrangements of component atoms represent a novel class of nanomaterials, exhibiting excellent performances towards various catalytic applications, e.g., carbon dioxide reduction reaction, oxygen reduction reaction, ethanol reduction reaction, and hydrogenation reaction. Although tremendous efforts have been devoted to the synthesis of noble metal-based intermetallic alloys with distinct crystal phases or architectures, most of the developed synthetic strategies can only yield intermetallic alloys with solid architectures and are not capable of tuning the crystal phase of products. The general and controlled preparation of hollow noble metal-based intermetallic alloys with different phases is highly desirable for the development of advanced catalysts and exploration of their structure-dependent performances.

### SUMMARY OF THE INVENTION

In accordance with a first aspect of the present invention, a method for synthesizing intermetallic nanoparticles is provided. The method comprises: preparing noble-metal nanoparticle seeds; dispersing a metal precursor into the noble-metal nanoparticle seeds to form a first mixture; adding the first mixture into an organic solvent to form a first solution; sonicating the first solution at room temperature; subjecting the first solution to a heat treatment under N₂ atmosphere to render a second solution; cooling the second solution naturally to room temperature; adding ethanol to the second solution to form a third solution; and collecting the intermetallic nanoparticle from the third solution by centrifugation.

In accordance with one embodiment, a heating temperature of the heat treatment ranges from 200° C. to 300° C.; and a heating time of the heat treatment is longer than 1 hour.

In accordance with another embodiment, the heating temperature is 250° C.; and the heating time is 3 hours.

In accordance with another embodiment, the noble-metal nanoparticle seeds are made of noble-metal nanoparticles with hexagonal close-packed phase such that the synthesized intermetallic nanoparticles are hollow intermetallic nanoparticles.

In accordance with another embodiment, the noble-metal nanoparticles with hexagonal close-packed phase are Pd nanoparticles and the metal precursor is a Sn precursor such that the synthesized intermetallic nanoparticles are hollow Pd—Sn intermetallic nanoparticles.

In accordance with another embodiment, a weight ratio of the Sn precursor to the Pd nanoparticles ranges from 3:2 to 4:1 such that the synthesized Pd—Sn intermetallic nanoparticles are hollow orthorhombic Pd₂Sn alloy nanoparticles.

In accordance with another embodiment, the weight ratio of the Sn precursor to the Pd nanoparticles is 12:7.

In accordance with another embodiment, the synthesized hollow orthorhombic Pd₂Sn alloy nanoparticles have an average particle size of 10.2±1.8 nm and an average void size of 5.2=1.1 nm.

In accordance with another embodiment, a weight ratio of the Sn precursor to the Pd nanoparticles ranges from 7:1 to 10:1 such that the synthesized Pd—Sn intermetallic nanoparticles are hollow monoclinic Pd₃Sn₂ alloy nanoparticles.

In accordance with another embodiment, the weight ratio of the Sn precursor to the Pd nanoparticles is 60:7.

In accordance with another embodiment, the synthesized hollow monoclinic Pd₃Sn₂ alloy nanoparticles have an average particle size of 11.5±2.9 nm and an average void size of 5.5±2.9 nm.

In accordance with another embodiment, the noble-metal nanoparticle seeds are made of noble-metal nanoparticles with face-centred cubic phase such that the synthesized intermetallic nanoparticles are solid intermetallic nanoparticles.

In accordance with another embodiment, the noble-metal nanoparticles with face-centred cubic (fcc) phase are Pd nanoparticles and the metal precursor is a Sn precursor such that the synthesized intermetallic nanoparticles are solid Pd—Sn intermetallic nanoparticles.

In accordance with another embodiment, a weight ratio of the Sn precursor to the Pd nanoparticles ranges from 3:2 to 4:1 such that the synthesized Pd—Sn intermetallic nanoparticles are solid orthorhombic Pd₂Sn alloy nanoparticles.

In accordance with another embodiment, the weight ratio of the Sn precursor to the Pd nanoparticles is 12:7.

In accordance with another embodiment, the synthesized solid orthorhombic Pd₂Sn alloy nanoparticles have an average particle size of 7.4±0.7 nm.

In accordance with a second aspect of the present invention, a method of using intermetallic nanoparticles made by the afore-said synthesis method as catalysts for an electrochemical glycerol oxidation reaction is provided.

The present invention provides a controllable and general seeded method for synthesizing distinct intermetallic alloy nanoparticles with hollow or solid architectures. The as-synthesized hollow orthorhombic Pd₂Sn (o-Pd₂Sn) alloy nanoparticles displays excellent glycerol oxidation reaction (GOR) performance with a high mass activity of 12.9 A·mg_{Pd}⁻¹, which is 14.3 times that of commercial Pd/C and among the best of reported Pd-based GOR catalysts. The superior catalytic performance of hollow o-Pd₂Sn compared to those of hollow monoclinic Pd₃Sn₂ (m-Pd₃Sn₂) and solid o-Pd₂Sn counterparts demonstrates the importance of simultaneously regulating the crystal phase and architecture of nanomaterials in enhancing their catalytic performance. Operando infrared reflection absorption spectroscopy (IRRAS) results suggest that hollow o-Pd₂Sn could accelerate the cleavage of C—C bond when compared with commercial Pd/C. Such delicate control over both the phase and architecture of alloys could provide important guidance for the development of advanced nanomaterials for promising applications.

### BRIEF DESCRIPTION OF THE DRAWINGS

Embodiments of the invention are described in more details hereinafter with reference to the drawings, in which:

FIGS. 1A to 1D illustrate transmission electron microscopy (TEM) image, size distribution histogram, selected area electron diffraction (SAED) pattern and Pd 3d X-ray photoelectron spectroscopy (XPS) spectrum of Pd nanoparticles (NPs) with 2H phase.

FIGS. 2A and 2B illustrate TEM image and scanning TEM (STEM) images of hollow o-Pd₂Sn NPs respectively. FIG. 2C illustrates energy dispersive X-ray spectroscopy (EDS) elemental line scan along the white line in a STEM image of a representative hollow o-Pd₂Sn NP (inset). FIG. 2D illustrates high-angle annular dark-field STEM (HAADF-STEM) image of a representative hollow o-Pd₂Sn NP. FIGS. 2E and 2F illustrate SAED pattern and X-ray diffraction (XRD) pattern of hollow o-Pd₂Sn NPs respectively.

FIG. 3A is schematic illustration of the particle size and void size of a typical hollow NP. FIGS. 3B and 3C are particle size and void size distribution histograms of hollow o-Pd₂Sn NPs, respectively.

FIG. 4A illustrates EDS and inductively coupled plasma optical emission spectrometry (ICP-OES) characterizations of hollow o-Pd₂Sn NPs. The additional element signals arise from the TEM grid. Inset: comparison of Pd and Sn contents based on the EDS and ICP-OES results. FIG. 4B illustrates STEM image and the corresponding EDS elemental mappings of hollow o-Pd₂Sn NPs.

FIGS. 5A and 5B illustrate Pd 3d and Sn 3d XPS spectra of hollow o-Pd₂Sn NPs, respectively.

FIGS. 6A and 6B illustrate TEM image and STEM image of hollow m-Pd₃Sn₂ NPs, respectively. FIG. 6C illustrates EDS elemental line scan along the white line in the STEM image (inset). FIG. 6D illustrates HAADF-STEM image of a representative hollow m-Pd₃Sn₂ NP. FIGS. 6E and 6F illustrate SAED pattern and XRD pattern (Inset of FIG. 6E: the corresponding model of crystal structures of m-Pd₃Sn₂) of hollow m-Pd₃Sn₂ NPs, respectively.

FIGS. 7A and 7B illustrate particle size and void size distribution histograms of hollow m-Pd₃Sn₂ NPs, respectively.

FIG. 8A illustrates EDS and ICP-OES characterizations of hollow m-Pd₃Sn₂ NPs. The additional element signals arise from the TEM grid. Inset: comparison of Pd and Sn contents based on the EDS and ICP-OES results. FIG. 8B illustrates STEM image and the corresponding EDS elemental mappings of hollow m-Pd₃Sn₂ NPs.

FIGS. 9A and 9B illustrate Pd 3d and Sn 3d XPS spectra of hollow m-Pd₃Sn₂ NPs, respectively.

FIGS. 10A to 10D illustrate TEM image, size distribution histogram, SAED pattern and Pd 3d XPS spectrum of fcc-Pd NPs, respectively.

FIGS. 11A and 11B illustrate TEM image and size distribution histogram of solid o-Pd₂Sn NPs, respectively. FIG. 11C illustrates EDS elemental line scan along the white line in the STEM image (inset) of a solid o-Pd₂Sn NP. FIG. 11D illustrates EDS and ICP-OES characterizations of solid o-Pd₂Sn NPs. The additional element signals arise from the TEM grid. Inset: comparison of Pd and Sn contents based on the EDS and ICP-OES results. FIGS. 11E and 11F illustrate high-resolution TEM (HRTEM) image and SAED pattern of solid o-Pd₂Sn NPs, respectively.

FIG. 12A illustrates cyclic voltammogram (CV) curves of hollow o-Pd₂Sn, solid o-Pd₂Sn, hollow m-Pd₃Sn₂, and commercial Pd/C, recorded in N₂-saturated 1.0 M KOH aqueous solution at a scan rate of 50 mV·s⁻¹. FIG. 12B illustrates CV curves of hollow o-Pd₂Sn, solid o-Pd₂Sn, hollow m-Pd₃Sn₂, and commercial Pd/C, recorded in N₂-saturated aqueous solution containing 1.0 M KOH and 1.0 M glycerol at a scan rate of 50 mV·s⁻¹. FIG. 12C illustrates mass activities (left panel) and specific activities (right panel) of hollow o-Pd₂Sn, solid o-Pd₂Sn, hollow m-Pd₃Sn₂, and commercial Pd/C at their corresponding peak potentials in the CV curves in FIG. 12B. FIG. 12D illustrates current transients at 0.9 V (vs. reversible hydrogen electrode (RHE)) from an initial potential of 0.5 V (vs. RHE) of hollow o-Pd₂Sn, solid o-Pd₂Sn, hollow m-Pd₃Sn₂, and commercial Pd/C in aqueous solution containing 1.0 M KOH and 1.0 M glycerol. FIG. 12E illustrates Tafel plots of hollow o-Pd₂Sn, solid o-Pd₂Sn, hollow m-Pd₃Sn₂, and commercial Pd/C.

FIG. 13A illustrates the calculated electrochemically active surface areas (ECSAs) of hollow o-Pd₂Sn, solid o-Pd₂Sn, hollow m-Pd₃Sn₂, and commercial Pd/C based on the corresponding CV curves. FIG. 13B illustrates ECSA-normalized CV curves of hollow o-Pd₂Sn, solid o-Pd₂Sn, hollow m-Pd₃Sn₂, and commercial Pd/C in N₂-saturated aqueous solution containing 1.0 M KOH and 1.0 M glycerol at a scan rate of 50 mV·s⁻¹.

FIGS. 14A to 14B illustrate TEM image and HRTEM image of the hollow o-Pd₂Sn catalyst after the durability test for GOR, respectively.

FIGS. 15A to 15F Operando IRRAS spectra recorded during the electrochemical GOR on the hollow o-Pd₂Sn (FIGS. 15A, 15C and 15E) and commercial Pd/C (FIGS. 15B, 15D and 15F) in Ar-saturated aqueous solution containing 0.1 M KOH and 0.1 M glycerol.

FIG. 16 illustrates proton nuclear magnetic resonance (¹H NMR) measurements of the products after GOR process on the hollow o-Pd₂Sn catalyst. DMSO was added as an internal standard. The water peak at around 4.7 ppm is suppressed with presaturation.

FIGS. 17A to 17F illustrate the 1H NMR reference spectra of glycerol, glyceric acid, glycolic acid, lactic acid, acetic acid, and formate. DMSO was added as an internal standard

FIG. 18 illustrates two pathways involved in a reaction mechanism of GOR in alkaline media.

### DETAILED DESCRIPTION

In the following description, embodiments of the present invention are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In one aspect of the present invention, a controlled and general method is provided for synthesizing distinct intermetallic alloy nanoparticles with hollow or solid architectures through wet-chemical reduction of a metal precursor and subsequent diffusion of the metal atoms into noble-metal nanoparticle NP seeds.

The controlled and general method comprises: preparing noble-metal nanoparticle NP seeds; dispersing a metal precursor into the noble-metal nanoparticle NP seeds to form a first mixture; adding the first mixture into an organic solvent (such as an amine, an alkene or a mixture thereof) to form a first solution; sonicating the first solution at room temperature; subjecting the first solution to a heat treatment under N₂ atmosphere to render a second solution; cooling the second solution naturally to room temperature; adding ethanol to the second solution to form a third solution; and collecting the hollow intermetallic nanomaterial from the third solution by centrifugation.

In some embodiments, hollow intermetallic alloy NPs may be synthesized by wet-chemical reduction of a metal precursor and subsequent diffusion of the metal atoms into seeds made of noble-metal NPs with 2H phase. For example, hollow PdSn intermetallic alloy NPs, such as orthorhombic Pd₂Sn (o-Pd₂Sn) NPs or monoclinic Pd₃Sn₂ (m-Pd₃Sn₂) NPs may be synthesized by wet-chemical reduction of Sn precursor and subsequent diffusion of Sn atoms into seeds made of Pd NPs with 2H phase (2H—Pd NPs).

### Synthesis of 2H—Pd NPs

2H—Pd nanoparticles may be prepared by heating the amorphous Pd (a-Pd) nanoparticles in an amine (e.g., oleylamine) in the absence of air. Typically, 1 mL of a-Pd nanoparticles in an organic solvent (e.g., toluene) was added to 12 mL of oleylamine in a 50 mL Schlenk tube under magnetic stirring. After stirring for 10 min at room temperature, the tube was evacuated for 10 min and then sealed to keep the high vacuum. Subsequently, the tube was placed into an oil bath at 180° C. and kept for 24 h, followed by natural cooling down to room temperature. After adding 20 mL of ethanol, the product was collected by centrifugation at 12,000 rpm for 10 min.

After the as-obtained 2H—Pd nanoparticles were dispersed into 5 mL of toluene and sonicated, 20 mL of ethanol were added to precipitate them. The 2H—Pd nanoparticles were then collected by centrifugation at 12,000 rpm for 10 min. The aforementioned washing process was repeated for twice.

The 2H—Pd nanoparticles were then re-dispersed in 1 mL of toluene. Subsequently, the aforementioned 2H—Pd nanoparticles were heated in oleylamine in air to remove the excess S-containing ligands capped on the surface. Typically, 1 mL of aforementioned 2H—Pd nanoparticles in toluene was added to 6 mL of oleylamine in a 20 mL vial under magnetic stirring. After stirring for 10 min at room temperature, the vial was placed into an oil bath at 130° C. and then kept for 6 h, followed by natural cooling down to room temperature. The final product was collected by centrifugation at 12,000 rpm for 10 min after adding 30 mL of ethanol.

After the 2H—Pd nanoparticles were dispersed into 5 mL of toluene and sonicated, 20 mL of ethanol were added to precipitate them. The washed 2H—Pd nanoparticles were then collected by centrifugation at 12,000 rpm for 10 min. Preferably, the aforementioned washing process was repeated for twice.

### Characterization of 2H—Pd NPs

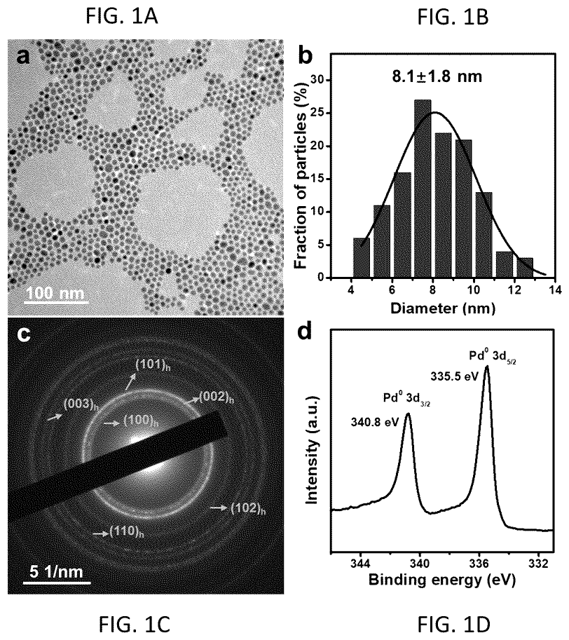

The TEM observation (FIG. 1A) shows the solid architecture of the as-synthesized 2H—Pd NPs with an average particle size of 8.1±1.8 nm (FIG. 1B). The 2H phase can be confirmed by the SAED pattern in FIG. 1C. XPS result confirms the metallic state of Pd element in 2H—Pd, in which the two peaks assigned to Pd⁰ 3d_{5/2} and Pd⁰ 3d_{3/2} locate at 335.5 and 340.8 eV, respectively (FIG. 1D).

Synthesis of Hollow o-Pd₂Sn NPs

In a typical synthesis of hollow o-Pd₂Sn NPs, 70 μg of the 2H—Pd NPs (determined by the ICP-OES) and 120 μg of SnCl₂ were dispersed into 2 mL of oleylamine in a 50 mL Schlenk tube and sonicated at room temperature to ensure the complete dissolution. Subsequently, the Schlenk tube was evacuated for 20 min at room temperature and purged with N₂ flow. After being sealed tightly, the Schlenk tube was heated by a metal bath at 250° C. under magnetic stirring for 3 hours, followed by natural cooling down to room temperature. The produced hollow o-Pd₂Sn NPs was collected by centrifugation at 10,000 rpm for 2 min after adding 2 mL of ethanol. Then the as-obtained hollow o-Pd₂Sn NPs were re-dispersed into 2 mL of organic solvent (e.g., toluene) and sonicated for 1 min, followed by adding 2 mL of ethanol to precipitate them. The hollow o-Pd₂Sn NPs was then collected by centrifugation at 10,000 rpm for 2 min. The aforementioned washing process was repeated twice. The washed hollow o-Pd₂Sn NPs were finally re-dispersed in toluene.

Characterization of Hollow o-Pd₂Sn NPs

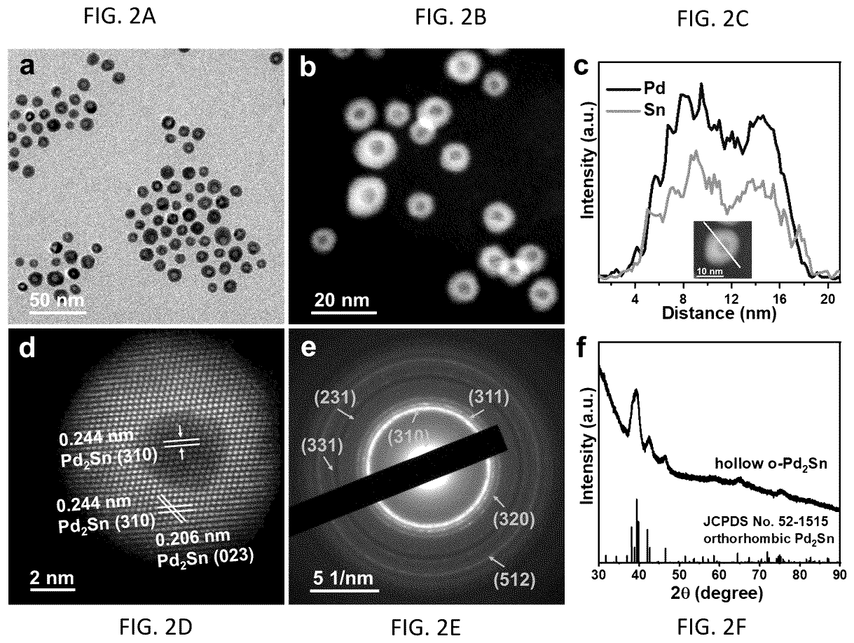

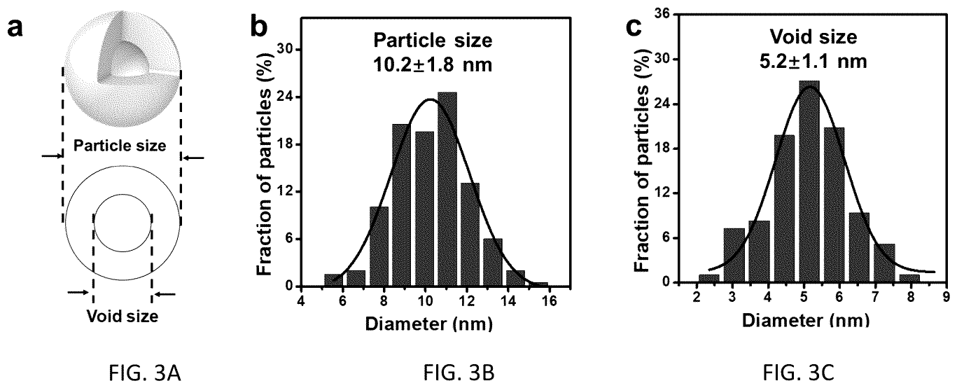

The hollow architecture of the synthesized o-Pd₂Sn NPs can be confirmed by TEM (FIG. 2A) and STEM images (FIG. 2B). The average particle size and void size of hollow o-Pd₂Sn NPs are 10.2±1.8 nm and 5.2±1.1 nm, respectively (FIGS. 3A-3C). The particle size of as-obtained hollow o-Pd₂Sn is larger than that of the 2H—Pd seeds (8.1±1.8 nm).

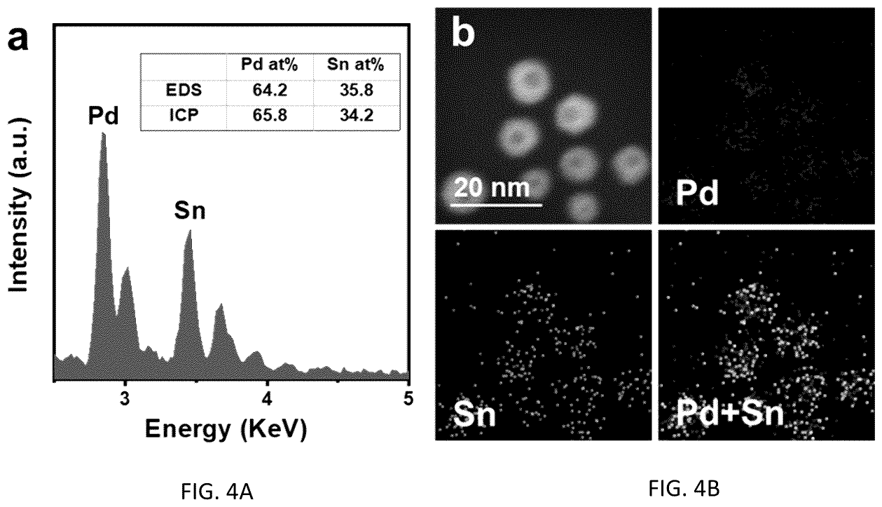

The atomic ratio of Pd/Sn in the hollow o-Pd₂Sn NPs is about 64/36 as determined by EDS spectrum and ICP-OES result (FIG. 4A). The comparison of Pd and Sn contents based on the EDS and ICP-OES results (inset of FIG. 4A) show a good agreement. The EDS mapping result (FIG. 4B) reveals the uniform distribution of Pd and Sn elements in the hollow o-Pd₂Sn NPs, indicating the formation of alloy structure. Moreover, EDS line scan of a typical hollow o-Pd₂Sn NP exhibits weaker signals of both Pd and Sn elements in the void part (FIG. 2C), further confirming the formation of hollow architecture.

The HAADF-STEM image of a representative hollow o-Pd₂Sn NP (FIG. 2D) shows clear lattice fringes with spacings of 0.244 and 0.206 nm, which correspond to (310) and (023) planes of o-Pd₂Sn intermetallic phase, respectively. The diffraction rings in the SAED pattern (FIG. 2E) and the diffraction peaks in the X-ray diffraction (XRD) pattern (FIG. 2F) can be well indexed to the orthorhombic phase, further corroborating the formation of o-Pd₂Sn intermetallic alloy with high phase purity.

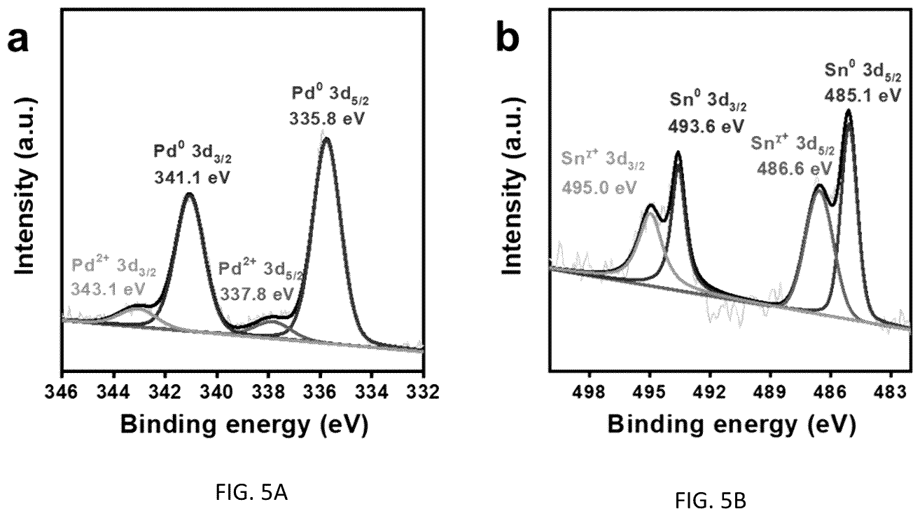

In addition, XPS spectra were measured to study the valence states of Pd and Sn in hollow o-Pd₂Sn NPs. The Pd 3d spectrum suggests the predominant metallic state of Pd element since the ratio of Pd⁰ is much higher than that of Pd₂ (FIG. 5A). It is also worth mentioning that the Pd⁰ 3d peaks at 335.8 and 341.1 eV in hollow o-Pd₂Sn NPs shift positively compared to those in 2H—Pd seeds (335.5 and 340.8 eV), indicating the change of electronic structure of Pd due to the alloying with Sn. Moreover, the Sn 3d spectrum demonstrates the mixed valence states of Sn element in hollow o-Pd₂Sn NPs with the co-existence of Sn⁰ and Sn^{χ+} (Sn²⁺ and/or Sn⁴⁺) (FIG. 5B).

Synthesis of Hollow m-Pd₃Sn₂ NPs

Typically, hollow m-Pd₃Sn₂ NPs may be synthesized by following the aforementioned method for the typical synthesis of hollow o-Pd₂Sn NPs except for except for increasing the amount of SnCl₂ from 120 μg to 600 μg.

Characterization of Hollow m-Pd₃Sn₂ NPs

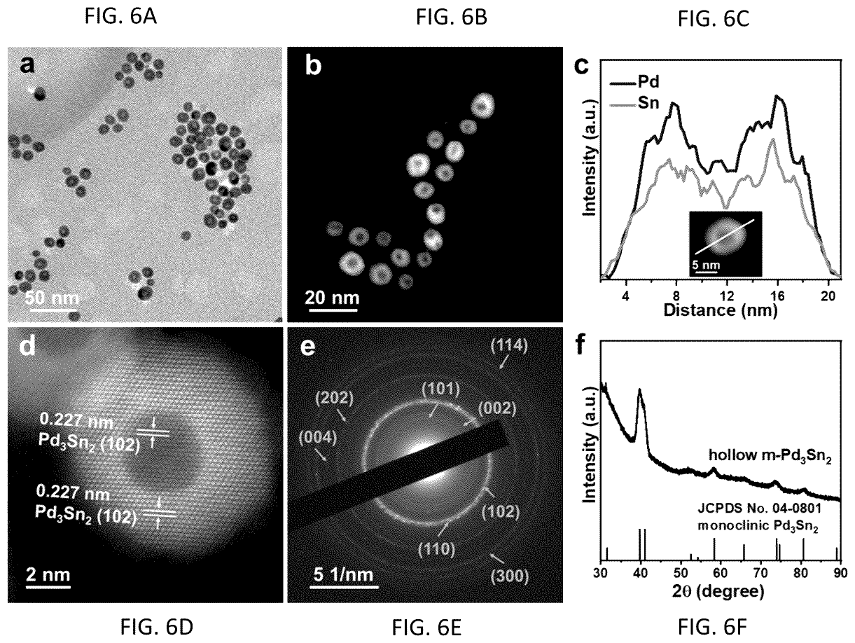

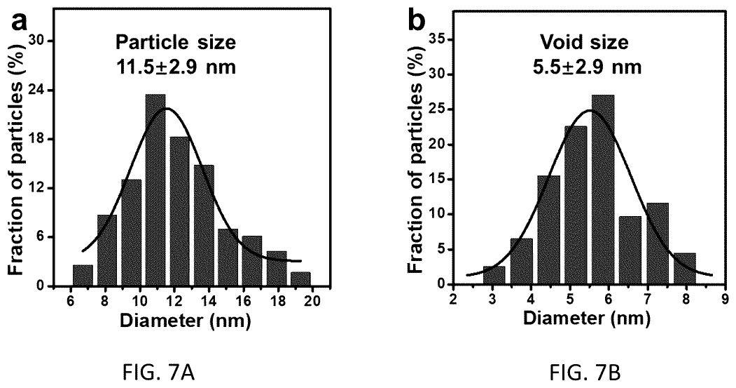

TEM (FIG. 6A) and STEM (FIG. 6B) images reveal the high uniformity and good dispersion of the obtained hollow m-Pd₃Sn₂ NPs with mean particle size and void size of 11.5±2.9 nm and 5.5±2.9 nm, respectively (FIGS. 7A-7B).

The hollow architecture of m-Pd₃Sn₂ NPs can be further verified by the obvious decrease of Pd and Sn signals in the middle part of EDS line scan profiles (FIG. 6C).

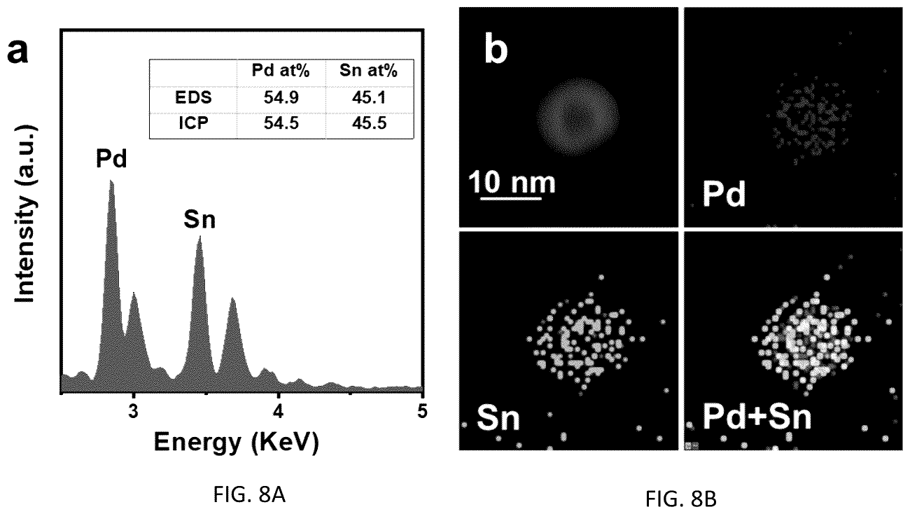

The Pd/Sn atomic ratio determined from the EDS spectrum is about 55/45, which is consistent with the ICP-OES result (FIG. 8A), and the alloying of Pd and Sn could be further confirmed by the EDS mapping results (FIG. 8B). The comparison of Pd and Sn contents based on the EDS and ICP-OES results (inset of FIG. 8A) show a good agreement.

HADDF-STEM image (FIG. 6D) shows clear lattice fringes with spacings of 0.227 nm in both the inner and outer parts, corresponding to the (102) plane of m-Pd₃Sn₂ phase. Besides, the diffraction rings in SAED pattern are well assigned to m-Pd₃Sn₂ phase (FIG. 6E), indicating the high phase purity, which is further affirmed by the XRD pattern (FIG. 6F).

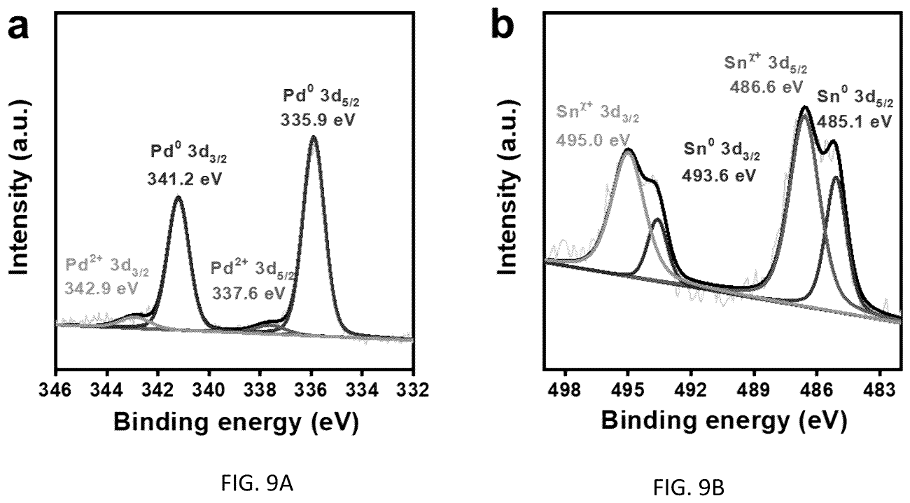

The valance states of Pd and Sn in hollow m-Pd₃Sn₂ NPs were also studied by XPS characterization. As revealed by the Pd 3d spectrum (FIG. 9A), Pd element is mainly in its metallic state. Similar to the XPS results of hollow o-Pd₂Sn NPs, the binding energies of Pd⁰ 3d peaks (335.9 and 341.2 eV) show a positive shift compared to those of 2H—Pd seeds (335.5 and 340.8 eV), and the Sn 3d spectrum (FIG. 9B) can be fit into two doublets that correspond to the metallic state and oxidated states of Sn, respectively.

In some other embodiments, solid intermetallic alloy may be synthesized by the wet-chemical reduction of a metal precursor and subsequent diffusion of the metal atoms into seeds made of noble-metal NPs with fcc phase. For example, solid PdSn intermetallic alloy NPs, such as, solid o-Pd₂Sn NPs, may be synthesized by wet-chemical reduction of Sn precursor and subsequent diffusion of Sn atoms into seeds made of Pd NPs with fcc phase (fcc-Pd NPs).

Synthesis of fcc-Pd NPs

In a typical synthesis of the fcc-Pd NPs, 0.25 mmol of palladium (II) acetylacetonate were dissolved in 15 mL of an amine (e.g., oleylamine) and subsequently heated to 60° C. under nitrogen gas flow and magnetic stirring. Then, 3 mL of oleylamine containing 0.2 g of borane morpholine complex were injected into the aforementioned solution. The temperature was slowly increased to 90° C. and kept for 30 min before cooling to room temperature. The fcc-Pd NPs were collected by centrifugation at 10,000 rpm for 10 min after adding 30 mL of ethanol. Preferably, the synthesized fcc-Pd NPs was washed twice with mixed solution of organic solvents (e.g., toluene and ethanol (v:v=1:6)) and finally dispersed in toluene.

Characterization of fcc-Pd NPs

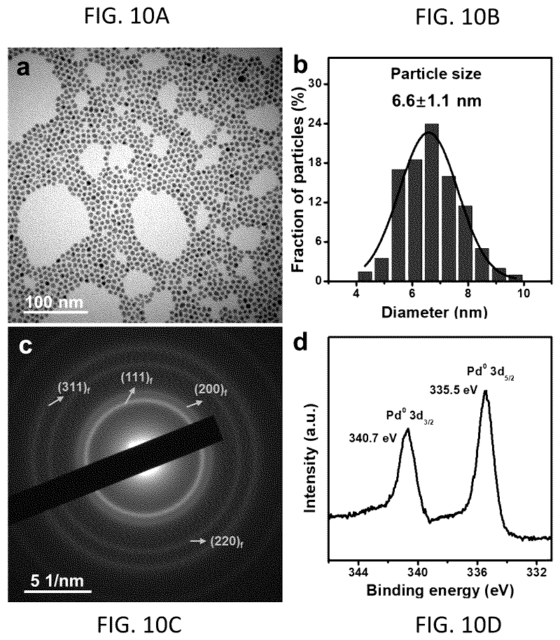

TEM image (FIG. 10A) shows the as-synthesized fcc-Pd NPs have average size of about 6.6±1.1 nm (FIG. 10B), which is close to that of 2H—Pd NPs. SAED pattern (FIG. 10C) indicates the formation of pure fcc phase. XPS result suggests that Pd element in fcc-Pd NPs is mainly in metallic state (FIG. 10D).

Synthesis of Solid o-Pd₂Sn NPs

Typically, solid o-Pd₂Sn NPs may be synthesized by following the aforementioned method for the typical synthesis of hollow o-Pd₂Sn NPs except for replacing the seeds made of 70 μg of 2H—Pd NPs to seeds made of 70 μg of fcc-Pd NPs.

Characterization of Solid o-Pd₂Sn NPs

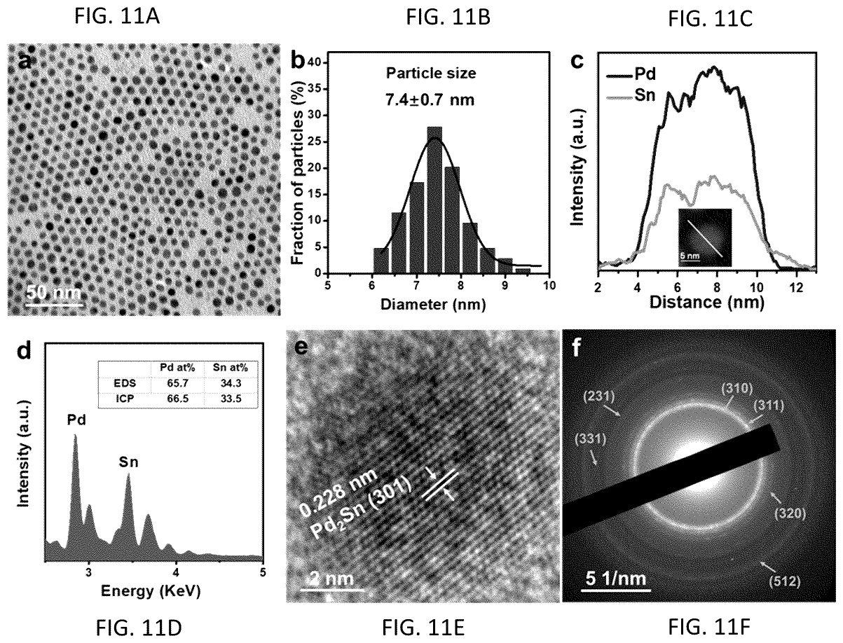

The solid o-Pd₂Sn NPs synthesized by using fcc-Pd NPs as seeds possess a sphere-like shape without the formation of voids (FIG. 11A) and an average size of 7.4±0.7 nm (FIG. 11B), which is slightly larger than that of the fcc-Pd seeds. EDS line scan of an individual solid o-Pd₂Sn NP suggests the homogenous distribution of Pd and Sn elements throughout the NP (FIG. 11C), further indicating the formation of solid architecture. As shown in FIG. 11D, the atomic ratio between Pd and Sn is determined as about 2/1 based on both the EDS spectrum and ICP-OES measurements. The comparison of Pd and Sn contents based on the EDS and ICP-OES results (inset of FIG. 11D) show a good agreement. In the HRTEM image (FIG. 11E), the measured lattice spacing of 0.228 nm can be indexed to the (301) plane of o-Pd₂Sn phase. The diffraction rings in the SAED pattern further corroborate the high phase purity of solid o-Pd₂Sn NPs (FIG. 11F).

It should be appreciated that the provided method can be used to other types of Pd-based intermetallic alloy nanoparticles with hollow or solid architectures, including, but not limited to, binary or ternary intermetallic Pd-based nanoparticles. More particularly, the intermetallic Pd-based nanoparticles may be any one of Pd—Bi, Pd—Pb, Pd—Cd, Pd—Zn, Pd—Cu, Pd—Sn—Cu, or Pd—Sn—Co nanoparticles.

In another aspect of the present invention, the as-prepared PdSn intermetallic alloys, including hollow o-Pd₂Sn, solid o-Pd₂Sn, and hollow m-Pd₃Sn₂, may be applied respectively as catalysts toward the electrochemical GOR in alkaline media.

### Preparation of Catalyst Inks

Typically, 10 mg of Vulcan XC-72R carbon black were first dispersed in 10 mL of ethanol and sonicated in an ice bath for 1 h to obtain a homogeneous solution. Subsequently, a catalyst solution containing 150 μg of one of the abovementioned as-prepared PdSn intermetallic alloy, determined by ICP-OES, was dropwise added into 1.35 mL of as-obtained carbon solution in a 4 mL glass vial, followed by sonication for another 1 h in an ice bath. Subsequently, the obtained catalyst on carbon (catalyst/C, 10 wt %) was collected by centrifugation at 14,800 rpm for 5 min, followed by washing five times with a mixed solvent of chloroform and ethanol (v:v=1:1). The obtained catalyst/C was finally dispersed in 1 mL of the mixture of Milli-Q water and isopropanol (v:v=3:7), and the concentration of Pd in catalyst/C was further determined by ICP-OES. Then, 100 μL of Nafion alcohol solution (5 wt %) were added in the catalyst/C solution, followed by sonication for another 30 min.

### Catalytic Performance Towards Electrochemical GOR

All electrochemical measurements were carried out in a standard three-electrode cell system using an electrochemical workstation (CHI 760E, CH Instrument, Inc.) at room temperature (˜25° C.). Glassy carbon electrode (GCE, 5 mm) coated with the prepared catalyst was used as the working electrode. Pt wire and Hg/HgO electrode were used as counter and reference electrodes, respectively. All potentials were converted into the values in reference to RHE, by using this formula: F(RHE)=F(Hg/HgO)+0.097+0.059×pH. Before each test, GCE was sequentially polished by Al₂O₃ slurry with particle sizes of 300 and 50 nm, followed by washing with Milli-Q water and ethanol to ensure a clean surface. Subsequently, the catalyst ink with 3 μg of catalysts/C was dropped onto the GCE surface and dried under ambient conditions. CV measurements of the working electrodes in N₂-saturated aqueous solution containing 1.0 M KOH were first carried out in a potential range from 0.1 to 1.3 V (vs. RHE) at a scan rate of 50 m V·s⁻¹ for 50 cycles to remove the ligands on catalyst surfaces and get stable CV curves. The ECSAs were calculated based on the charge required for oxygen desorption, that is, from the area of the reduction peak of PdO in the as-obtained CV curves.

The ECSA values (in terms of m²·g_{Pd}⁻¹) of the catalysts were estimated based on the equation, ECSA=Q/(0.405×m_{Pd}), where Q is the coulombic charge by integrating peak areas of the reduction of PdO (mC), m_{Pd} is the Pd loading (mg·cm⁻²), and the constant (0.405) represents the charge required for the reduction of PdO monolayer (mC·cm⁻²_{Pd}).

Then, the activity of the catalysts towards GOR was evaluated by CV measurements in a mixed N₂-saturated solution containing 1.0 M KOH and 1.0 M glycerol between 0.1 and 1.3 V (vs. RHE) at 50 mV·s⁻¹. Current transients were carried out by stepping the potential from 0.5 to 0.9 V (vs. RHE) and holding the potential for 30 s. The Tafel slopes of these catalysts were carried out in the mixed solution containing 1.0 M KOH and 1.0 M glycerol at a scan rate of 50 mV·s⁻¹. The stability of the catalysts was evaluated by chronoamperometric measurements at 0.9 V (vs. RHE) for 3,600 s in the mixed solution containing 1.0 M KOH and 1.0 M glycerol.

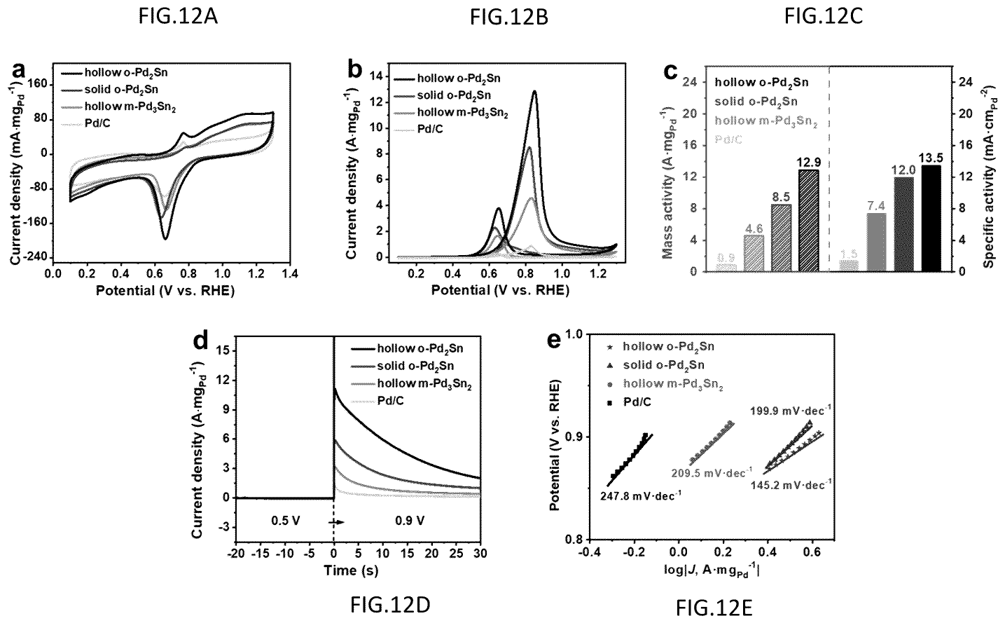

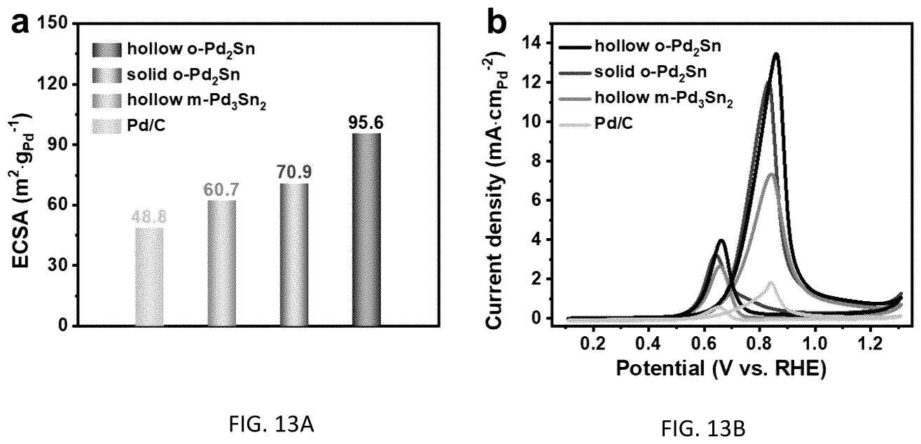

FIG. 12A shows the CV measurements of the aforementioned catalysts and commercial Pd/C in N₂-saturated aqueous electrolyte containing 1.0 M KOH. The obvious peaks in the potential range of 0.4-0.9 V (versus reversible hydrogen electrode (vs. RHE)) are attributed to the reduction of PdO. Among these catalysts, hollow o-Pd₂Sn shows the strongest reduction peak of PdO, implying the exposure of more Pd active sites. According to the peak area of the reduction of PdO, the ECSAs were calculated. Hollow o-Pd₂Sn shows an ECSA value of 95.6 m²·g_{Pd}⁻¹, which is much higher than those of solid o-Pd₂Sn (70.9 m²·g_{Pd}⁻¹), hollow m-Pd₃Sn₂ (60.7 m²·g_{Pd}⁻¹), and Pd/C (48.8 m²·g_{Pd}⁻¹) (FIG. 13A). To assess the GOR performance of these catalysts, the CV measurements were carried out in N₂-saturated aqueous solution containing 1.0 M KOH and 1.0 M glycerol at 50 mV·s⁻¹. As shown in FIG. 12B, hollow o-Pd₂Sn exhibits the highest mass current in the potential range of 0.5-0.9 V (vs. RHE) among all catalysts. The mass activity of hollow o-Pd₂Sn is determined to be 12.9 A·mg_{Pd}⁻¹, which is 1.5, 2.8, and 14.3 times those of solid o-Pd₂Sn (8.5 A·mg_{Pd}⁻¹), hollow m-Pd₃Sn₂ (4.6 A·mg_{Pd}⁻¹), and Pd/C (0.9 A·mg_{Pd}⁻¹), respectively (FIG. 12C). As shown in Table 1, such high mass activity of hollow o-Pd₂Sn puts it among the best of previously reported Pd-based electrocatalysts toward GOR.

TABLE 1
Summary of electrochemical GOR performances of
Pd-based catalysts under alkaline conditions

| | | Mass activity |
|---|---|---|
| | | (A · |
| Catalyst | Electrolyte | mg_{noble metal}⁻¹) |
| Hollow | 1.0M KOH + 1.0M glycerol | 12.9 |
| o-Pd₂Sn NPs | | |
| Solid | 1.0M KOH + 1.0M glycerol | 8.5 |
| o-Pd₂Sn NPs | | |
| Pd—Ru nanocages | 1.0M KOH + 1.0M glycerol | 6.3 |
| fcc-2H-fcc Au@Pd | 1.0M KOH + 0.1M glycerol | 1.87 |
| nanorods | | |
| PdCu nanoparticles@ | 1.0M KOH + 1.0M glycerol | 1.87 |
| graphene | | |
| Pd_{50.2}Cu_{38.4}Pt_{11.4} | 1.0M KOH + 1.0M glycerol | 9.7 |
| twin icosahedrons | | |
| PdBi nanosheet | 1.0M KOH + 1.0M glycerol | 3.04 |
| assemblies | | |
| Pd/graphene foam | 1.0M KOH + 1.0M glycerol | 2.72 |
| Pt₃₂Pd₄₈Ni₂₀ | 1.0M KOH + 0.1M glycerol | 5.63 |
| nanosheets | | |
| PdAuAg nanocages | 1.0M KOH + 1.0M glycerol | 5.68 |
| Pd—WO_{2.75} nanobelts | 1.0M KOH + 1.0M glycerol | 4.9 |
| PdPt nanowire | 1.0M KOH + 0.1M glycerol | 1.8 |
| network | | |
| PdPb alloy nanocubes | 1.0M KOH + 1.0M glycerol | 2.22 |
| PdMoSb trimetallene | 0.5M KOH + 0.5M glycerol | 2.19 |
| Pd₆₂Au₂₁Ni₁₇ | 1.0M KOH + 0.1M glycerol | 3.3 |
| nanosponges | | |

The mass currents of these catalysts were further normalized to their corresponding ECSAs for better comparison of their intrinsic activities, and the specific currents were shown in FIG. 13B. Notably, hollow o-Pd₂Sn shows the highest specific activity of 13.5 mA·cm_{Pd}⁻², which is 1.1, 1.8, and 9.0 times those of solid o-Pd₂Sn (12.0 mA·cm_{Pd}⁻²), hollow m-Pd₃Sn₂ (7.4 mA·cm_{Pd}⁻²), and Pd/C (1.5 mA·cm_{Pd}⁻²), respectively (FIG. 12C).

To further compare the GOR activities, the current transients of these catalysts were performed using chronoamperometric measurements by instantaneously stepping from the potential of 0.5 V (vs. RHE) where the GOR was negligible to the potential of 0.9 V (vs. RHE) (typical potential for GOR). As shown in FIG. 12D, the initial sharp current transit represents the response of catalysts for the oxidation of glycerol, and the following current decay to a quasi-steady state originates from the accumulation and adsorption of poisoning species formed during the GOR process, such as strongly adsorbed CO (CO_{ad}), on the catalyst surface. Among all the as-synthesized catalysts, hollow o-Pd₂Sn delivers the highest mass current for the oxidation of glycerol, which is in good agreement with the trend observed in CV curves (FIG. 12B).

The Tafel analysis was conducted to further investigate the reaction kinetics on these catalysts (FIG. 12E). The hollow o-Pd₂Sn exhibits a Tafel slope of 145.2 mV·dec⁻¹, which is lower than those of solid o-Pd₂Sn (199.9 mV·dec⁻¹), hollow m-Pd₃Sn₂ (209.5 mV·dec⁻¹), and Pd/C (247.8 mV·dec⁻¹), indicating its fast reaction kinetics in GOR.

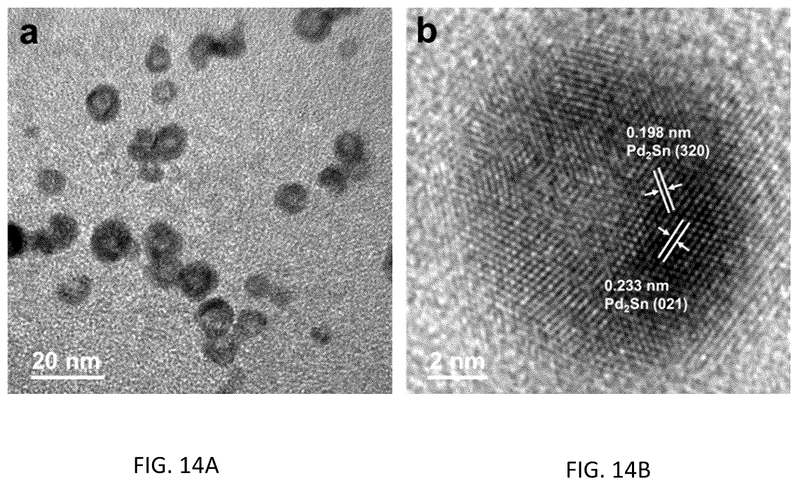

The stability of catalysts was also evaluated by the chronoamperometric measurements at 0.9 V (vs. RHE). After the durability tests of GOR process for 3,600 s, hollow o-Pd₂Sn can still deliver the highest mass activity among these catalysts. Moreover, the morphology and phase of hollow o-Pd₂Sn were well maintained after the durability test (FIGS. 14A and 14B), indicating the good structural stability of the catalyst.

The aforementioned results demonstrate that the hollow o-Pd₂Sn catalyst shows better GOR performance than its solid counterpart, which could be attributed to the intrinsic advantages of hollow architecture. Furthermore, hollow o-Pd₂Sn and solid o-Pd₂Sn both exhibit superior GOR performances, including higher activity and better stability, to the hollow m-Pd₃Sn₂, suggesting the decisive role of the crystal phase of catalyst in modulating its catalytic performance.

The excellent GOR performance of hollow o-Pd₂Sn could be originated from the following aspects. First, it is commonly accepted that alloying Pd with other transition metals like Sn could modify the electronic band structure of Pd-based nanomaterials, which contributes to the enhanced performance towards GOR. In this work, the change of electronic band structure of Pd in hollow o-Pd₂Sn can be verified by the positive shift of binding energies in Pd 3d XPS spectrum as compared to those of pure Pd. Secondly, previous studies have revealed that noble metal-based intermetallic alloys could exhibit excellent catalytic performance because of their ordered atomic arrangements and unique electronic structures. In this work, the outstanding GOR performance of hollow o-Pd₂Sn could also be originated from the unconventional orthorhombic intermetallic phase, which endows it with higher intrinsic catalytic activity, abundant active sites, and favorable reaction kinetics, as revealed by the highest specific activity, largest ECSA area, and lowest Tafel slope among all the as-prepared catalysts, respectively. Thirdly, catalysts with hollow architectures are featured with large specific surface area and enhanced utilization of noble metals, endowing them with promising catalytic performance, which also explains the better GOR activity of hollow o-Pd₂Sn than that of solid o-Pd₂Sn. Therefore, the alloying effect of Pd and Sn, ordered intermetallic structure, and hollow architecture simultaneously contribute to the excellent GOR performance of the hollow o-Pd₂Sn catalyst.

Operando IRRAS measurements

To provide deeper insight into the reaction mechanism during GOR on the hollow o-Pd₂Sn catalyst, operando IRRAS studies were performed. Specifically, we conducted operando IRRAS measurements on the hollow o-Pd₂Sn and Pd/C catalysts with potentials varying from 0.1 to 1.3 V (vs. RHE) in Ar-saturated aqueous solution containing 0.1 M KOH and 0.1 M glycerol.

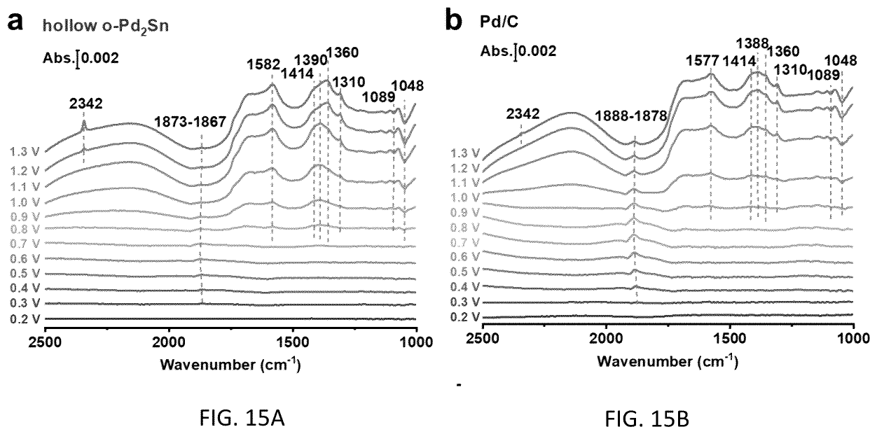

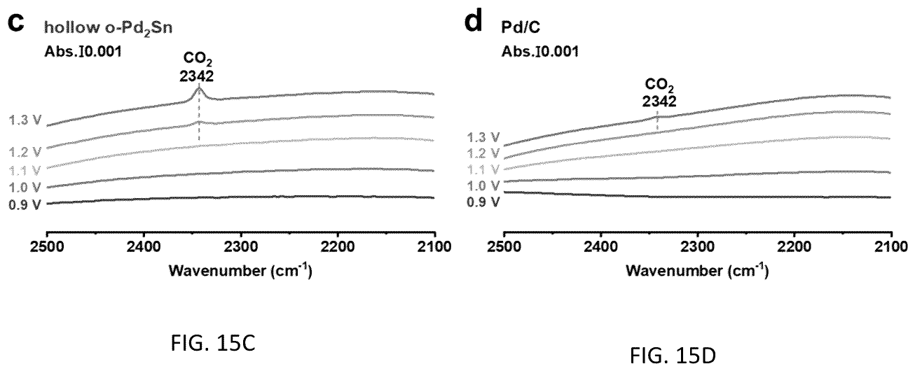

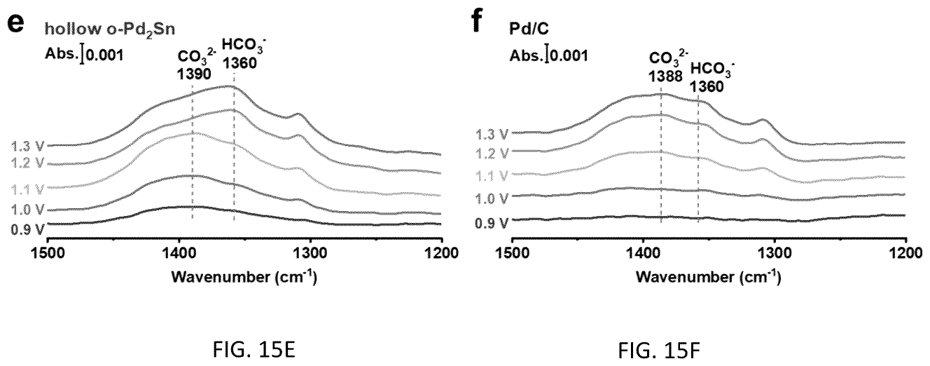

As displayed in FIGS. 15A and 15B, two downward bands located at 1048 and 1089 cm⁻¹ represent typical C—O vibration in alcohol molecules, confirming the consumption of glycerol reactants. The upward band at 1310 cm⁻¹ is a typical feature of C—O stretching of glyceraldehyde or glycerate ion, which is accompanied by two upward bands at around 1414 and 1580 cm⁻¹ that belong to the symmetric and asymmetric stretching of O—C—O, respectively, demonstrating the formation of carboxylate ions, including glycerate and acetate ions, during the reaction over both catalysts.

In addition, hollow o-Pd₂Sn catalyst shows much weaker signals of triply bonded CO (CO_{T}) at 1873-1867 cm⁻¹ as compared to Pd/C (located at 1888-1878 cm⁻¹) from 0.3 to 1.3 V (vs. RHE), suggesting a better anti-poisoning ability to *CO. Notably, the signal of CO₂ is also detected at 2342 cm⁻¹ on both catalysts (FIGS. 15C and 15D). In comparison, the CO₂ band on hollow o-Pd₂Sn appears from a lower potential (1.2 V vs. RHE) than that on Pd/C (1.3 V vs. RHE), and the band intensity ratio between CO₂ (2342 cm⁻¹) and carboxylate ions (1414 cm⁻¹) is also higher over hollow o-Pd₂Sn.

These results indicate that hollow o-Pd₂Sn is more capable of breaking the C—C bond for complete oxidation of glycerol to generate CO₂ compared with Pd/C. Moreover, two bands at around 1390 and 1360 cm⁻¹ are corresponding to the existence of CO₃²⁻ and HCO₃⁻, respectively, which are sequentially generated from the continuous reaction between produced CO₂ and the alkaline electrolyte. As shown in FIG. 15E, the band intensity of HCO₃⁻ can even surpass that of CO₃²⁻ on hollow o-Pd₂Sn at high potentials of 1.2 to 1.3 V (vs. RHE), while the CO₃²⁻ band was stronger than HCO₃⁻ on Pd/C at all potentials (FIG. 15F), revealing the more significant generation of CO₂ and thereby a stronger C—C cleavage capability of hollow o-Pd₂Sn catalyst.

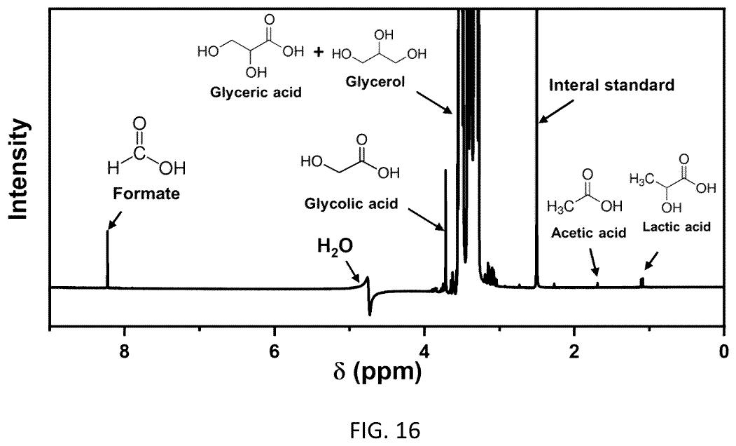

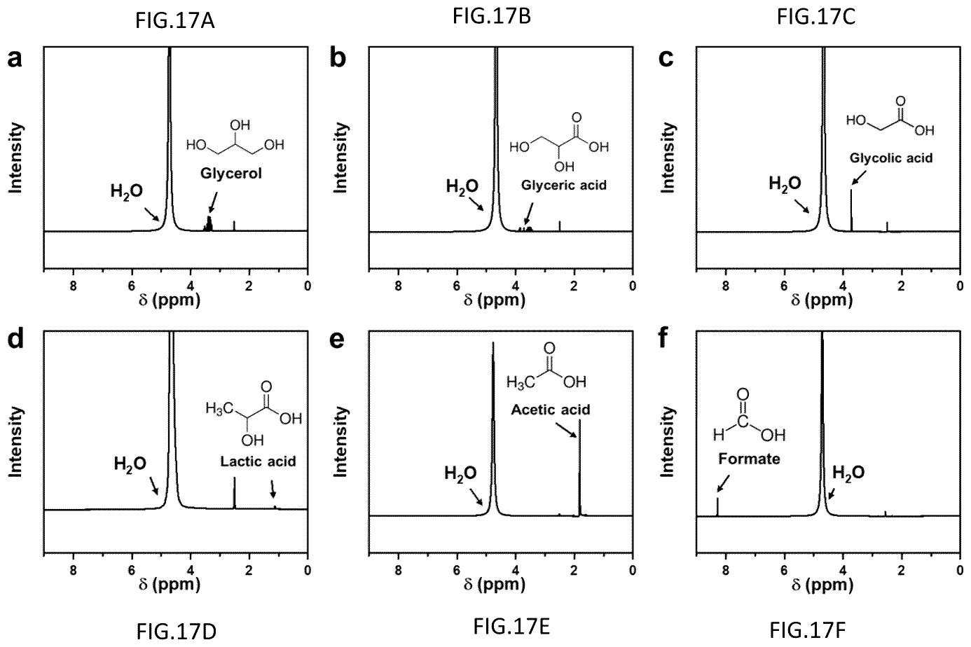

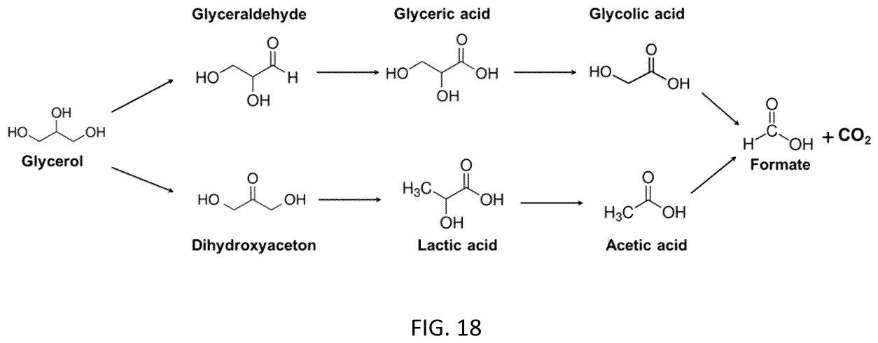

The products after GOR process over hollow o-Pd₂Sn were further analyzed by 1H NMR to clarify the reaction pathway. The co-existence of formate, acetic acid, lactic acid, glycolic acid, glycerate, and the remaining glycerol was detected in the products (FIG. 16 and FIGS. 17A-17F). Based on the IRRAS and 1H NMR results, a reaction mechanism involving two pathways for GOR in this work is proposed and displayed in FIG. 18.

The embodiments may be chosen and described in order to best explain the principles of the invention and its practical application, thereby enabling others skilled in the art to understand the invention for various embodiments and with various modifications that are suited to the particular use contemplated. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations. While the apparatuses disclosed herein have been described with reference to particular structures, shapes, materials, composition of matter and relationships . . . etc., these descriptions and illustrations are not limiting. Modifications may be made to adapt a particular situation to the objective, spirit and scope of the present disclosure. All such modifications are intended to be within the scope of the claims appended hereto.

What is claimed is:

1. A method for synthesizing intermetallic nanoparticles, comprising:
preparing noble-metal nanoparticle seeds;
dispersing a metal precursor into the noble-metal nanoparticle seeds to form a first mixture;
adding the first mixture into an organic solvent to form a first solution;
sonicating the first solution at room temperature;
subjecting the first solution to a heat treatment under N₂ atmosphere to render a second solution;
cooling the second solution naturally to room temperature;
adding ethanol to the second solution to form a third solution; and
collecting the intermetallic nanoparticle from the third solution by centrifugation.

2. The method of claim 1, wherein a heating temperature of the heat treatment ranges from 200° C. to 300° C.; and a heating time of the heat treatment is longer than 1 hour.

3. The method of claim 2, wherein the heating temperature is 250° C.; and the heating time is 3 hours.

4. The method of claim 1, wherein the noble-metal nanoparticle seeds are made of noble-metal nanoparticles with hexagonal close-packed phase such that the synthesized intermetallic nanoparticles are hollow intermetallic nanoparticles.

5. The method of claim 4, wherein the noble-metal nanoparticles with hexagonal close-packed phase are Pd nanoparticles and the metal precursor is a Sn precursor such that the synthesized intermetallic nanoparticles are hollow Pd—Sn intermetallic nanoparticles.

6. The method of claim 5, wherein a weight ratio of the Sn precursor to the Pd nanoparticles ranges from 3:2 to 4:1 such that the synthesized Pd—Sn intermetallic nanoparticles are hollow orthorhombic Pd₂Sn alloy nanoparticles.

7. The method of claim 6, wherein the weight ratio of the Sn precursor to the Pd nanoparticles is 12:7.

8. The method of claim 7, wherein the synthesized hollow orthorhombic Pd₂Sn alloy nanoparticles have an average particle size of 10.2±1.8 nm and an average void size of 5.2±1.1 nm.

9. The method of claim 5, wherein a weight ratio of the Sn precursor to the Pd nanoparticles ranges from 7:1 to 10:1 such that the synthesized Pd—Sn intermetallic nanoparticles are hollow monoclinic Pd₃Sn₂ alloy nanoparticles.

10. The method of claim 9, wherein the weight ratio of the Sn precursor to the Pd nanoparticles is 60:7.

11. The method of claim 10, wherein the synthesized hollow monoclinic Pd₃Sn₂ alloy nanoparticles have an average particle size of 11.5±2.9 nm and an average void size of 5.5±2.9 nm.

12. The method of claim 1, wherein the noble-metal nanoparticle seeds are made of noble-metal nanoparticles with face-centred cubic phase such that the synthesized intermetallic nanoparticles are solid intermetallic nanoparticles.

13. The method of claim 12, wherein the noble-metal nanoparticles with face-centred cubic phase are Pd nanoparticles and the metal precursor is a Sn precursor such that the synthesized intermetallic nanoparticles are solid Pd—Sn intermetallic nanoparticles.

14. The method of claim 13, wherein a weight ratio of the Sn precursor to the Pd nanoparticles ranges from 3:2 to 4:1 such that the synthesized Pd—Sn intermetallic nanoparticles are solid orthorhombic Pd₂Sn alloy nanoparticles.

15. The method of claim 14, wherein the weight ratio of the Sn precursor to the Pd nanoparticles is 12:7.

16. The method of claim 15, wherein the synthesized solid orthorhombic Pd₂Sn alloy nanoparticles have an average particle size of 7.4±0.7 nm.

17. A method of using intermetallic nanoparticles made by the method of claim 1 as catalysts for an electrochemical glycerol oxidation reaction.
